(19) United States
(12) Patent Application Publication
(10) Pub. No.: US 2019/0257351 A1
(43) Pub. Date: Aug. 22, 2019

(54) Safe soft hooks

(71) Applicant: LENA JOHNSON, OKLAHOMA CITY, OK (US)

(72) Inventor: LENA JOHNSON, OKLAHOMA CITY, OK (US)

(21) Appl. No.: 15/932,388

(22) Filed: Feb. 21, 2018

(51) Int. Cl. F16B 45/00; A47G 33/10; D21J 1/16

(52) U.S. Cl. CPC F16B 45/00; D21J 1/16; A47G 33/10

(57) ABSTRACT

A safe soft hanger hook for hanging small object replacing metal hanger hooks retaining a variety of shapes which reduces risks and hazards to children and small pets who might attempt to consume them, reduces the potential of damage to household appliances used to clean floors and carpets, and will not penetrate the skin in the event the safe hanger hook is stepped on, the safe soft hanger hooks made of a material which dissolves and softens when exposed to moisture, water or saliva, the safe hanger hooks being recyclable and disposed of in an ecological manner.

### CROSS REFERENCE TO RELATED APPLICATIONS

None.

### I. BACKGROUND OF THE INVENTION

### 1. Field of Invention

A safe soft hanger hook for hanging small object replacing metal hanger hooks retaining a variety of shapes which reduces risks and hazards to children and small pets who might attempt to consume them, reduces the potential of damage to household appliances used to clean floors and carpets, and will not penetrate the skin in the event the safe hanger hook is stepped on, the safe soft hanger hooks made of a material which dissolves and softens when exposed to moisture, water or saliva, the safe hanger hooks being recyclable and disposed of in an ecological manner.

### 2. Description of Prior Art

A preliminary review of prior art patents was conducted by the applicant which reveal prior art patents in a similar field or having similar use. However, the prior art inventions do not disclose the same or similar elements as the present safe hanger hooks, nor do they present the material components in a manner contemplated or anticipated in the prior art.

Several examples on the market involve hanging hooks made of metal or plastic used to hang ornaments from a tree or from a nail or wall mount. In U.S. Pat. No. D654,351 a hanging hook made of paper is shown defining an upper hook portion and a lower portion having a pair of split angular tabs defining a shaped opening in each tab wherein a hook may be inserted or some other vertically oriented object may be inserted and held. Two clothing hangers are disclosed in U.S. Pat. No. 7,311,230 to Yeh, describing a clothing hanger being made entirely of pressed paper formed into a hanger, and U.S. Pat. No. 8,152,034 to Chang which has linear sections made of paper stock and glue and connectors made of metal. None appears to meet the design, utility or functional objectives of the present safe hanger hooks.

### II. SUMMARY OF THE INVENTION

Wire hooks are commonly used to hang ornamental items. These hooks have been used for years to hang Christmas ornaments on trees, to attach items to wreaths and garlands, and to hang items on doors, windows, sashes, hearths and about anywhere one would attach a decorative item. Common complaints include entanglement of these hooks, which is a minor inconvenience, with major harmful events include being stepped on, being aspirated by or causing a choking hazard to small children or household pets, damage to a digestive system and injury the mouth. Along with damage to person or pet, they are often caught in carpets, picked up by vacuum cleaners, scratch wooden floors or get caught in furniture fabrics.

The present invention provides a functionally similar hook made of a fibrous or paper product which may or may not include a binding agent, which is supplied to serve as a hanger for the same items while avoiding the above noted hazards and inconveniences noted above. The physical characteristic of the material used in this product would possess the characteristics including being biodegradable, flexible, non-penetrating to flesh, significantly reduced as an oral and digestive hazard, and harmless in the event of ingestion by a person or pet. It would also break down and partially dissolve when contacting moisture and reduce or eliminate damage to a vacuum or other cleaning machine.

### III. DESCRIPTION OF THE DRAWINGS

The following drawings are submitted with this utility patent application.

FIG. 1 is a front and rear view of the safe hanger hook.

FIG. 2 is a side view of the safe hanger hook.

FIG. 3 is a second embodiment of the lower hook portion.

FIG. 4 is a front and rear view of a third embodiment of the safe hanger hook.

FIG. 5 is an embodiment of the safe hanger hook integrated within an expanded ornamental central portion.

FIG. 6 is a view of FIG. 2 as used to hang a Christmas ornament from a branch of a Christmas tree.

### IV. DESCRIPTION OF THE PREFERRED EMBODIMENT

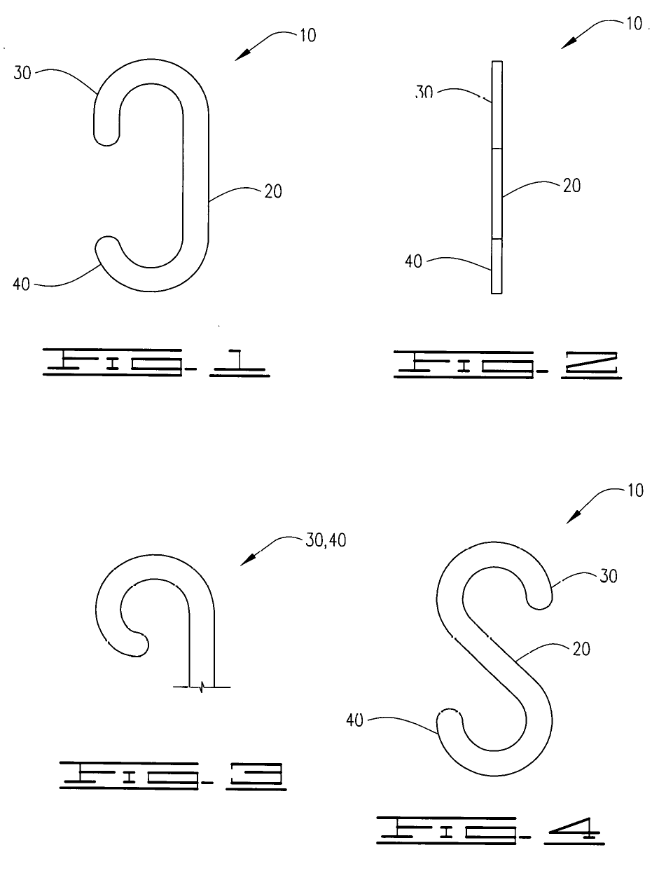

A safe hanger hook 10 for hanging objects, FIGS. 1-6, replacing the previous metal or wire hooks, presents a safe alternative to the metal and wire hooks, the safe hanger hook made from a non-toxic paper, fibrous or fabric material avoiding choking hazards to children and pets and also avoid damages to the digestive track if swallowed, avoiding foot penetration if stepped upon by a bar foot, avoiding damage and being caught in carpets and fabrics, avoiding damage to vacuum cleaners and other cleaning appliances, and decaying or recycling after use making them disposable or appropriate for reuse at the discretion of the user. The safe hanger hook 10 dissolves when exposed to water or saliva. This provides for the hook to become instantly soft when placed in the mouth, and further to decay into a benign bolus of paper or soft material that will not harm a digestive track nor result in any toxic danger to those who do ingest the hooks. The safe hanger hooks 10 suspend objects from nails, walls, other hooks, suction cups and seasonal trees, FIG. 7, vines or garlands and to suspend decorative items, or in any such manner and would be used with the traditional metal or wire hooks, having broad choice and selection of the shape, design and supplemental and beneficial features of the traditional metal or wire hooks.

Each safe hanger hook 10 defines a central hook body 20, an upper hook portion 30, and a lower hook portion 40, FIGS. 1-4. Once again, the material chosen for the safe hanger hook 10 must be a paper, fiber or fabric material having the characteristics as indicated above, provided it becomes soft and loses its integrity and shape when exposed to a liquid. They may also include coatings, hinders, adhesives or additives to enhance certain physical properties of the material, including weather and water proofing, stiffening, softening and such additives may be provided over the entire safe hanger hook or in certain areas requiring the additional physical enhancements. For example, additional strength may be required in the upper or lower hook portion 30, 40, to make them more rigid than the body to resist deformation from the weight of the objects being hung from the safe hanger hook. The blank material would best be provided as a sheet material, which may be of uniform thickness, or each safe hanger hook 10 may have portions that are laminated or have certain areas thicker than others.

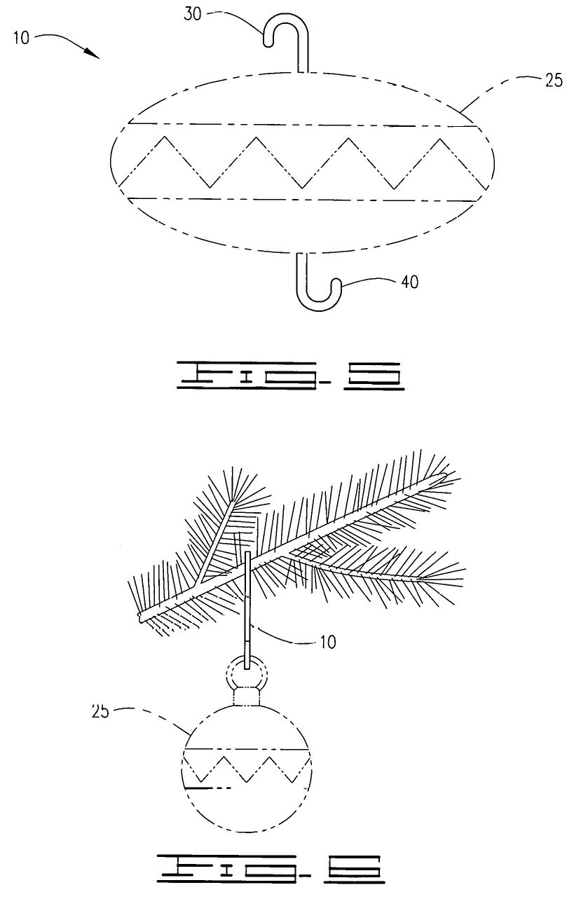

The shape of the safe hanger hook 10 may be C-shaped, FIGS. 1-2 and 6, S-shaped, FIG. 4, or provided as an upper and lower extension to an ornamental expansion 25 integrated as the central hook body 20, FIG. 5. The each upper and lower hook portion 30, 40, may be defined as a half circle, as indicated in FIGS. 1-2 and 4-6, or a more full semi-circular embodiment as shown in FIG. 3, provided to assist purchase of each hook portion either from the hanging device or the object being hung. The upper and lower hook portions 30, 40, do not require symmetry, and may incorporate different shapes and sizes between the upper hook portion 30 and lower hook portion 40. They may also be a shape other than a C or an S, provided the upper and lower hook portions 30, 40, would engage the same secondary hanging properties as those shown.

The central hook body 20 may optionally provide the ornamental expansion 25, as illustrated by example in FIG. 5, including holiday symbols, letters, numbers and other images without complex manufacturing requirements, especially where the hooks are cut from a sheet material. These cuts are easily made by desktop cutters, CNC machines, roll cutters or many modern manufacturing devices that would be ideally suited for the making of these safe hanger hooks 10 in many different shapes, sizes, textures, designs and thicknesses. It is preferred that these central hook bodies 20 incorporate as many designs as could be produced to increase the market potential of these products, including not only shapes and sizes, but a variety of colors and surface textures, including glitter, metallic surface foils, pearls, patterns and additional “bling”.

The orientation of the upper and lower hook portion 30, 40, may provide same side openings, FIGS. 1-2, or opposing side openings, FIG. 4, as already discussed. The hook portions may also be provided as one or more upper hook portions combined with one or more lower hook portions for multiple item suspension or multiple points of suspension of the safe hanger hooks 10. As a manufactured sale product, each safe hanger hook 10 may be provided by each individual hook, a plurality of hooks which are the same or in variety of shapes, sizes, colors and other physical distinctions or, because of the unique presentation of the safe hanger hooks 10, in a punch-out sheet which can be used by a consumer as needed, leaving the remaining safe hanger hooks 10 in the sheet in the punch-out sheet until required.

Required traits of the safe hanger hooks 10 include accelerated degradation by liquid exposure after use for enhanced environmental responsibility. For example, by using a paper product for the production of the hooks, water or saliva would accelerate the decay of the waste or disposed hook after damage or concluded use, which would render the disposed hooks soft and easily incorporated into either a recycled product or a friendly waste product which can be used for soil enhancement instead of contamination. Reuse or recycling is encouraged.

It is the primary intent, however, to reduce choking hazards to children and pets in the event they place the safe hanger hook 10 in their mouths and to avoid internal damage in the event they hooks are ingested, and a secondary intent to reduce damage to carpet or floor cleaning devices in the event they are on the floor or in the carpet to reduce the damage potential to the cleaning apparatus, i.e. vacuum cleaners, wet mops, dry mops or brooms, which could also harm the floors if embedded within the cleaning apparatus during use.

Although the embodiments of the safe hanger hooks 10 have been described and shown above, it will be appreciated by those skilled in the art that numerous modifications may be made therein without departing from the scope of the invention as herein described.

I Claim:

1. A safe hanger hook for hanging objects on a wall, branch or other stationary location, each safe hanger hook comprising:
a paper product which decays rapidly when exposed to liquid to avoid a choking hazard or injury to a child or pet when ingested;
an upper hook portion;
a lower hook portion; and
a central hook body extending said upper hook portion and said lower hook portion, wherein said upper hook portion is attached to a nail, pin or extension from a wall, a branch or a tree, a suction cup attached to glass, or any other stationary location from which another object is hung, thereby replacing metal hooks traditionally used by a consumer which pose a choking hazard to children and pets, can cause damage to the digestive track if swallowed, or can cause damage to components of cleaning appliances as well as carpets and floors.

2. The safe hanger hook of claim 1 further comprising:
said central hook body is an ornamental expansion selected from a group including holiday symbols, letters, numbers and other images for seasonal or occasional purposes.

3. The safe hanger hook of claim 1 further comprising:
said upper hook portion, central hook body and said lower hook portion form a C-shaped hook.

4. The safe hanger hook of claim 1 further comprising:
said upper hook portion, central hook body and said lower hook portion form an S-shaped hook.

5. (canceled)
